(19) United States
(12) Patent Application Publication
(10) Pub. No.: US 2025/0244583 A1
(43) Pub. Date: Jul. 31, 2025

(54) Tunable Lens with Mitigation of Magnification Changes

(71) Applicant: Apple Inc., Cupertino, CA (US)

(72) Inventors: Pablo Benitez Gimenez, Madrid (ES); Pablo Zamora Herranz, Madrid (ES)

(21) Appl. No.: 18/948,234

(22) Filed: Nov. 14, 2024

Related U.S. Application Data
(60) Provisional application No. 63/626,420, filed on Jan. 29, 2024.

(51) Int. Cl. G02B 27/01; G02B 27/00

(52) U.S. Cl. CPC G02B 27/0172; G02B 27/0093; G02B 27/0176; G02B 2027/0163

(57) ABSTRACT

An electronic device may include a lens module with a tunable lens. User comfort when operating the electronic device may be improved by mitigating changes in magnification at different optical powers of the lens module. One technique to mitigate changes in magnification at different optical powers is to physically move a tunable lens in the lens module relative to a non-tunable lens in the lens module to change a gap between the tunable lens and the non-tunable lens. Another technique is to include two tunable lenses such as an adjustable positive optical power lens and an adjustable negative optical power lens in the lens module. Instead or in addition, adjustments to a tunable lens in a lens module may be performed during one or more eye blinks and/or over a transition period.

This application claims the benefit of U.S. provisional patent application No. 63/626,420, filed Jan. 29, 2024, which is hereby incorporated by reference herein in its entirety.

### BACKGROUND

This relates generally to electronic devices and, more particularly, to wearable electronic device systems.

Electronic devices are sometimes configured to be worn by users. For example, head-mounted devices are provided with head-mounted structures that allow the devices to be worn on users' heads. The head-mounted devices may include optical systems with lenses.

Head-mounted devices typically include lenses with fixed shapes and properties. If care is not taken, it may be difficult to adjust these types of lenses to optimally present content to each user of the head-mounted device.

### SUMMARY

An electronic device may include a head-mounted support structure and a lens module coupled to the head-mounted support structure comprising a first lens with a fixed optical power, a second lens with an adjustable optical power, and at least one positioner configured to selectively adjust a gap between the first and second lenses.

An electronic device may include a head-mounted support structure, a lens module that is coupled to the head-mounted support structure, that is configured to focus light towards an eye box, and that comprises a first lens with an adjustable positive optical power and a second lens with an adjustable negative optical power, and control circuitry configured to change the lens module from a first state with first total optical power to a second state with a second total optical power that is greater than the first total optical power by increasing the adjustable positive optical power of the first lens and decreasing the adjustable negative optical power of the second lens. Perceived magnification at the eye box may be the same in both the first and second states.

A method of operating an electronic device with a tunable lens and one or more sensors may include determining that an optical power adjustment for the tunable lens is needed using data from a first subset of the one or more sensors, detecting an eye blink using a second subset of the one or more sensors after determining that the optical power adjustment for the tunable lens is needed, and adjusting an optical power of the tunable lens according to the optical power adjustment after detecting the eye blink using the second subset of the one or more sensors.

A method of operating an electronic device with a tunable lens and one or more sensors may include determining that an optical power adjustment for the tunable lens is needed using data from a first subset of the one or more sensors and adjusting an optical power of the tunable lens over a transition period of at least 200 milliseconds after determining that the optical power adjustment for the tunable lens is needed.

### BRIEF DESCRIPTION OF THE DRAWINGS

FIG. 1 is a schematic diagram of an illustrative electronic device in accordance with some embodiments.

FIG. 2 is a top view of an illustrative head-mounted device with a lens module in accordance with some embodiments.

FIG. 3 is a side view of an illustrative lens module in accordance with some embodiments.

FIGS. 4 and 5 are side views of an illustrative tunable lens in different tuning states in accordance with some embodiments.

FIG. 6 is a state diagram showing illustrative modes of operation for a tunable lens in an electronic device in accordance with some embodiments.

FIGS. 7A and 7B are side views of an illustrative lens module where the gap between an adjustable lens and a non-adjustable lens is adjustable to enable mitigation of magnification changes caused by changes in optical power in the adjustable lens in accordance with some embodiments.

FIGS. 8A and 8B are side views of an illustrative lens module with two adjustable lenses separated by a fixed, non-zero gap in accordance with some embodiments.

FIG. 9 is a flowchart of an illustrative method for operating an electronic device with a tunable lens in accordance with some embodiments.

### DETAILED DESCRIPTION

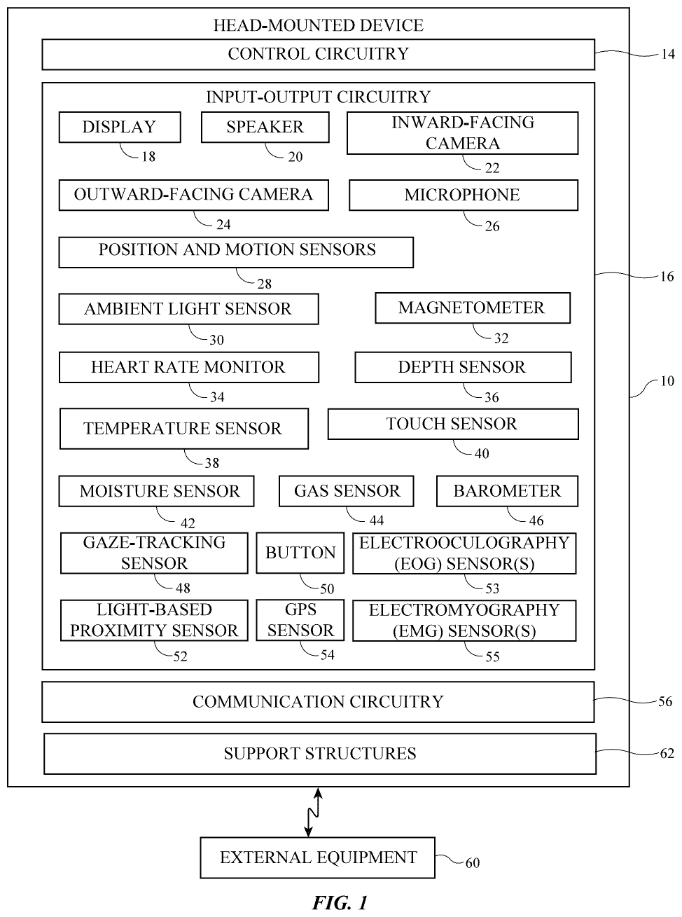

A schematic diagram of an illustrative electronic device is shown in FIG. 1. As shown in FIG. 1, electronic device 10 (sometimes referred to as head-mounted device 10, system 10, head-mounted display 10, etc.) may have control circuitry 14. In addition to being a head-mounted device, electronic device 10 may be other types of electronic devices such as a cellular telephone, laptop computer, speaker, computer monitor, electronic watch, tablet computer, etc. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 16. Input-output circuitry 16 may be used to allow a user to provide head-mounted device 10 with user input. Input-output circuitry 16 may also be used to gather information on the environment in which head-mounted device 10 is operating. Output components in circuitry 16 may allow head-mounted device 10 to provide a user with output.

As shown in FIG. 1, input-output circuitry 16 may include a display such as display 18. Display 18 may be used to display images for a user of head-mounted device 10. Display 18 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18 is opaque, the display may also optionally display entirely computer-generated content (e.g., without displaying images of the physical environment).

Display 18 may include one or more optical systems (e.g., lenses) (sometimes referred to as optical assemblies) that allow a viewer to view images on display(s) 18. A single display 18 may produce images for both eyes or a pair of displays 18 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

The example of device 10 including a display is merely illustrative and display(s) 18 may be omitted from device 10 if desired. Device 10 may include an optical pass-through area where real-world content is viewable to the user either directly or through a tunable lens.

Input-output circuitry 16 may include various other input-output devices. For example, input-output circuitry 16 may include one or more speakers 20 that are configured to play audio and one or more microphones 26 that are configured to capture audio data from the user and/or from the physical environment around the user.

Input-output circuitry 16 may so include one or more cameras such as an inward-facing camera 22 (e.g., that faces the user's face when the head-mounted device is mounted on the user's head) and an outward-facing camera 24 (that face the physical environment around the user when the head-mounted device is mounted on the user's head). Cameras 22 and 24 may capture visible light images, infrared images, or images of any other desired type. The cameras may be stereo cameras if desired. Inward-facing camera 22 may capture images that are used for gaze-detection operations, in one possible arrangement. Outward-facing camera 24 may capture pass-through video for head-mounted device 10.

As shown in FIG. 1, input-output circuitry 16 may include position and motion sensors 28 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 28, for example, control circuitry 14 can monitor the current direction in which a user's head is oriented relative to the surrounding environment (e.g., a user's head pose). One or more of cameras 22 and 24 may also be considered part of position and motion sensors 28. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16 may also include other sensors and input-output components if desired. As shown in FIG. 1, input-output circuitry 16 may include an ambient light sensor 30. The ambient light sensor may be used to measure ambient light levels around head-mounted device 10. The ambient light sensor may measure light at one or more wavelengths (e.g., different colors of visible light and/or infrared light).

Input-output circuitry 16 may include a magnetometer 32. The magnetometer may be used to measure the strength and/or direction of magnetic fields around head-mounted device 10.

Input-output circuitry 16 may include a heart rate monitor 34. The heart rate monitor may be used to measure the heart rate of a user wearing head-mounted device 10 using any desired techniques.

Input-output circuitry 16 may include a depth sensor 36. The depth sensor may be a pixelated depth sensor (e.g., that is configured to measure multiple depths across the physical environment) or a point sensor (that is configured to measure a single depth in the physical environment). The depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 16 may include a temperature sensor 38. The temperature sensor may be used to measure the temperature of a user of head-mounted device 10, the temperature of head-mounted device 10 itself, or an ambient temperature of the physical environment around head-mounted device 10.

Input-output circuitry 16 may include a touch sensor 40. The touch sensor may be, for example, a capacitive touch sensor that is configured to detect touch from a user of the head-mounted device.

Input-output circuitry 16 may include a moisture sensor 42. The moisture sensor may be used to detect the presence of moisture (e.g., water) on, in, or around the head-mounted device.

Input-output circuitry 16 may include a gas sensor 44. The gas sensor may be used to detect the presence of one or more gases (e.g., smoke, carbon monoxide, etc.) in or around the head-mounted device.

Input-output circuitry 16 may include a barometer 46. The barometer may be used to measure atmospheric pressure, which may be used to determine the elevation above sea level of the head-mounted device.

Input-output circuitry 16 may include a gaze-tracking sensor 48 (sometimes referred to as gaze-tracker 48 and gaze-tracking system 48). The gaze-tracking sensor 48 may include a camera and/or other gaze-tracking sensor components (e.g., light sources that emit beams of light so that reflections of the beams from a user's eyes may be detected) to monitor the user's eyes. Gaze-tracker 48 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 48 is merely illustrative.

Input-output circuitry 16 may include a button 50. The button may include a mechanical switch that detects a user press during operation of the head-mounted device.

Input-output circuitry 16 may include a light-based proximity sensor 52. The light-based proximity sensor may include a light source (e.g., an infrared light source) and an image sensor (e.g., an infrared image sensor) configured to detect reflections of the emitted light to determine proximity to nearby objects.

Input-output circuitry 16 may include one or more electrooculography (EOG) sensors 53. Electrooculography is a technique for measuring the electric potential between the front and back of the human eye. To measure the electric potential, one or more pairs of electrodes may be placed in contact with the skin on opposing sides of the eye (e.g., above and below the eye or on the left and right sides of the eye). Herein, electrodes used to measure electric potential for electrooculography may be referred to as electrooculography sensors or EOG sensors.

Input-output circuitry 16 may include a global positioning system (GPS) sensor 54. The GPS sensor may determine location information for the head-mounted device. The GPS sensor may include one or more antennas used to receive GPS signals. The GPS sensor may be considered a part of position and motion sensors 28.

Input-output circuitry 16 may include one or more electromyography (EMG) sensors 55. Electromyography is a technique for measuring electrical activity in response to a nerve's stimulation of a muscle. The electromyography sensors may therefore be able to determine when a muscle is engaged. To measure the electrical activity associated with a muscle, one or more pairs of electrodes may be placed in contact with the skin. Herein, electrodes used to measure electric potential for electromyography may be referred to as electromyography sensors or EMG sensors.

Input-output circuitry 16 may include any other desired components (e.g., capacitive proximity sensors, other proximity sensors, strain gauges, pressure sensors, audio components, haptic output devices such as vibration motors, light-emitting diodes, other light sources, etc.).

Head-mounted device 10 may also include communication circuitry 56 to allow the head-mounted device to communicate with external equipment (e.g., a tethered computer, a portable device such as a handheld device or laptop computer, one or more external servers, or other electrical equipment). Communication circuitry 56 may be used for both wired and wireless communication with external equipment.

Communication circuitry 56 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

During operation, head-mounted device 10 may use communication circuitry 56 to communicate with external equipment 60. External equipment 60 may include one or more external servers, an electronic device that is paired with head-mounted device 10 (such as a cellular telephone, a laptop computer, a speaker, a computer monitor, an electronic watch, a tablet computer, earbuds, etc.), a vehicle, an internet of things (IoT) device (e.g., remote control, light switch, doorbell, lock, smoke alarm, light, thermostat, oven, refrigerator, stove, grill, coffee maker, toaster, microwave, etc.), etc.

Electronic device 10 may have housing structures (e.g., housing walls, straps, etc.), as shown by illustrative support structures 62 of FIG. 1. In configurations in which electronic device 10 is a head-mounted device (e.g., a pair of glasses, goggles, a helmet, a hat, etc.), support structures 62 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support control circuitry 14, input-output circuitry 16, and/or communication circuitry 56.

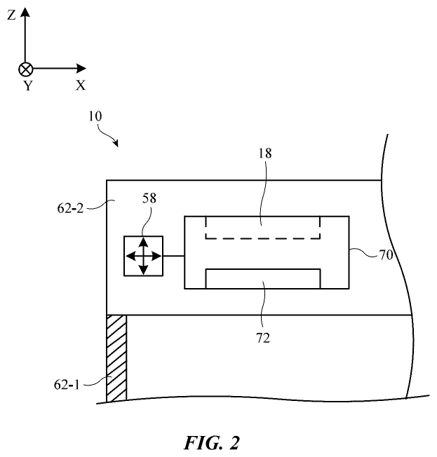

FIG. 2 is a top view of electronic device 10 in an illustrative configuration in which electronic device 10 is a head-mounted device. As shown in FIG. 2, electronic device 10 may include support structures (see, e.g., support structures 62 of FIG. 1) that are used in housing the components of device 10 and mounting device 10 onto a user's head. These support structures may include, for example, structures that form housing walls and other structures for main unit 62-2 (e.g., exterior housing walls, lens module structures, etc.) and eyeglass temples or other supplemental support structures such as structures 62-1 that help to hold main unit 62-2 on a user's face.

The electronic device may include optical modules such as optical module 70. The electronic device may include left and right optical modules that correspond respectively to a user's left eye and right eye. An optical module corresponding to the user's left eye is shown in FIG. 2.

Each optical module 70 includes a corresponding lens module 72 (sometimes referred to as lens stack-up 72, lens 72, or adjustable lens 72). Lens 72 may include one or more lens elements arranged along a common axis. Each lens element may have any desired shape and may be formed from any desired material (e.g., with any desired refractive index). The lens elements may have unique shapes and refractive indices that, in combination, focus light (e.g., from a display or from the physical environment) in a desired manner. Each lens element of lens module 72 may be formed from any desired material (e.g., glass, a polymer material such as polycarbonate or acrylic, a crystal such as sapphire, etc.).

Modules 70 may optionally be individually positioned relative to the user's eyes and relative to some of the housing wall structures of main unit 26-2 using positioning circuitry such as positioner 58. Positioner 58 may include stepper motors, piezoelectric actuators, motors, linear electromagnetic actuators, and/or other electronic components for adjusting the position of displays, the optical modules 70, and/or lens modules 72. Positioners 58 may be controlled by control circuitry 14 during operation of device 10. For example, positioners 58 may be used to adjust the spacing between modules 70 (and therefore the lens-to-lens spacing between the left and right lenses of modules 70) to match the interpupillary distance IPD of a user's eyes. In another example, the lens module may include an adjustable lens element. The curvature of the adjustable lens element may be adjusted in real time by positioner(s) 58 to compensate for a user's eyesight and/or viewing conditions.

Each optical module may optionally include a display such as display 18 in FIG. 2. As previously mentioned, the displays may be omitted from device 10 if desired. In this type of arrangement, the device may still include one or more lens modules 72 (e.g., through which the user views the real world). In this type of arrangement, real-world content may be selectively focused for a user.

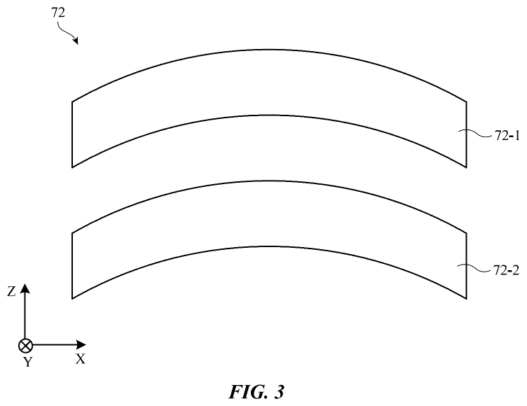

FIG. 3 is a cross-sectional side view of an illustrative lens module with multiple lens elements. As shown, lens module 72 includes a first lens element 72-1 and a second lens element 72-2. Each surface of the lens elements may have any desired curvature. For example, each surface may be a convex surface (e.g., a spherically convex surface, a cylindrically convex surface, or an aspherically convex surface), a concave surface (e.g., a spherically concave surface, a cylindrically concave surface, or an aspherically concave surface), a combination of convex and concave surfaces, or a freeform surface. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In some cases, one of the lens surfaces may have an aspheric surface that changes from being convex (e.g., at the center) to concave (e.g., at the edges) at different positions on the surface. This type of surface may be referred to as an aspheric surface, a primarily convex (e.g., the majority of the surface is convex and/or the surface is convex at its center) aspheric surface, a freeform surface, and/or a primarily convex (e.g., the majority of the surface is convex and/or the surface is convex at its center) freeform surface. A freeform surface may include both convex and concave portions and/or curvatures defined by polynomial series and expansions. Alternatively, a freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. In one example, shown in FIG. 3, lens element 72-1 has a convex surface that faces display 18 and an opposing concave surface. Lens element 72-2 has a convex surface that faces lens element 72-1 and an opposing concave surface.

One or both of lens elements 72-1 and 72-2 may be adjustable. In one example, lens element 72-1 is a non-adjustable lens clement whereas lens element 72-2 is an adjustable lens element. The adjustable lens element 72-2 may be used to accommodate a user's eyeglass prescription, for example. The shape of lens element 72-2 may be adjusted if a user's eyeglass prescription changes (without needing to replace any of the other components within device 10). As another possible use case, a first user with a first eyeglass prescription (or no eyeglass prescription) may use device 10 with lens element 72-2 having a first shape and a second, different user with a second eyeglass prescription may use device 10 with lens element 72-2 having a second shape that is different than the first shape. Lens element 72-2 may have varying lens power and/or may provide varying amounts and orientations of astigmatism correction to provide prescription correction for the user.

The example of lens module 72 including two lens elements is merely illustrative. In general, lens module 72 may include any desired number of lens elements (e.g., one, two, three, four, more than four, etc.). Any subset or all of the lens elements may optionally be adjustable. Any of the adjustable lens elements in the lens module may optionally be fluid-filled adjustable lenses. Lens module 72 may also include any desired additional optical layers (e.g., partially reflective mirrors that reflect 50% of incident light, linear polarizers, retarders such as quarter wave plates, reflective polarizers, circular polarizers, reflective circular polarizers, etc.) to manipulate light that passes through lens module.

In one possible arrangement, lens element 72-1 may be a removable lens element. In other words, a user may be able to easily remove and replace lens element 72-1 within optical module 70. This may allow lens element 72-1 to be customizable. If lens element 72-1 is permanently affixed to the lens assembly, the lens power provided by lens clement 72-1 cannot be easily changed. However, by making lens element 72-1 customizable, a user may select a lens element 72-1 that best suits their eyes and place the appropriate lens element 72-1 in the lens assembly. The lens clement 72-1 may be used to accommodate a user's eyeglass prescription, for example. A user may replace lens element 72-1 with an updated lens element if their eyeglass prescription changes (without needing to replace any of the other components within electronic device 10). Lens element 72-1 may have varying lens power and/or may provide varying amount of astigmatism correction to provide prescription correction for the user. Lens element 72-1 may include one or more attachment structures that are configured to attach to corresponding attachment structures included in optical module 70, lens element 72-2, support structures 26, or another structure in electronic device 10.

In contrast with lens element 72-1, lens clement 72-2 may not be a removable lens element. Lens element 72-2 may therefore sometimes be referred to as a permanent lens element, non-removable lens element, etc. The example of lens element 72-2 being a non-removable lens element is merely illustrative. In another possible arrangement, lens element 72-2 may also be a removable lens element (similar to lens element 72-1).

As previously mentioned, one or more of the adjustable lens elements may be a fluid-filled lens element. An example is described herein where lens element 72-2 from FIG. 3 is a fluid-filled lens element. When lens element 72-2 is a fluid-filled lens element, the lens element may include one or more components that define the surfaces of lens element 72-2. These elements may also be referred to as lens elements. In other words, adjustable lens element 72-2 (sometimes referred to as adjustable lens module 72-2, adjustable lens 72-2, tunable lens 72-2, etc.) may be formed by multiple respective lens elements.

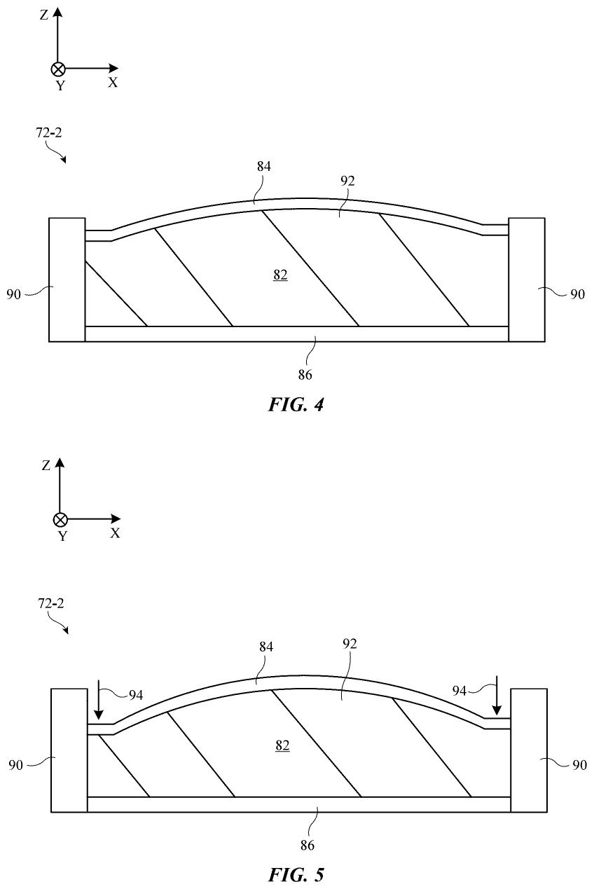

FIG. 4 is a cross-sectional side view of adjustable fluid-filled lens element 72-2. As shown, fluid-filled chamber 82 (sometimes referred to as chamber 82 or fluid chamber 82) that includes fluid 92 is interposed between lens elements 84 and 86. Fluid 92 may be a liquid, gel, or gas with a pre-determined index of refraction (and may therefore sometimes be referred to as liquid 92, gel 92, or gas 92). The fluid may sometimes be referred to as an index-matching oil, an optical oil, an optical fluid, an index-matching material, an index-matching liquid, etc. Lens elements 84 and 86 may have the same index of refraction or may have different indices of refraction. Fluid 92 that fills chamber 82 between lens elements 84 and 86 may have an index of refraction that is the same as the index of refraction of lens element 84 but different from the index of refraction of lens element 86, may have an index of refraction that is the same as the index of refraction of lens element 86 but different from the index of refraction of lens element 84, may have an index of refraction that is the same as the index of refraction of lens element 84 and lens element 86, or may have an index of refraction that is different from the index of refraction of lens element 84 and lens element 86. Lens elements 84 and 86 may have a circular footprint, may have an elliptical footprint, may have or may have a footprint any another desired shape (e.g., an irregular footprint).

The amount of fluid 92 in chamber 82 may have a constant volume or an adjustable volume. If the amount of fluid is adjustable, the lens module may also include a fluid reservoir and a fluid controlling component (e.g., a pump, stepper motor, piezoelectric actuator, motor, linear electromagnetic actuator, and/or other electronic component that applies a force to the fluid in the fluid reservoir) for selectively transferring fluid between the fluid reservoir and the chamber.

Lens elements 84 and 86 may be transparent lens elements formed from any desired material (e.g., glass, a polymer material such as polycarbonate or acrylic, a crystal such as sapphire, etc.). Each one of lens elements 84 and 86 may be elastomeric, semi-rigid, or rigid. Elastomeric lens elements may be formed from a natural or synthetic polymer that has a low Young's modulus for high flexibility. For example the elastomeric membrane may be formed from a material having a Young's modulus of less than 1 GPa, less than 0.5 GPa, less than 0.1 GPa, etc.

Semi-rigid lens elements may be formed from a semi-rigid material that is stiff and solid, but not inflexible. A semi-rigid lens element may, for example, be formed from a thin layer of polymer or glass. Semi-rigid lens elements may be formed from a material having a Young's modulus that is greater than 1 Gpa, greater than 2 GPa, greater than 3 GPa, greater than 10 GPa, greater than 25 GPa, etc. Semi-rigid lens elements may be formed from polycarbonate, polyethylene terephthalate (PET), polymethylmethacrylate (PMMA), acrylic, glass, or any other desired material. The properties of semi-rigid lens elements may result in the lens element becoming rigid along a first axis when the lens element is curved along a second axis perpendicular to the first axis or, more generally, for the product of the curvature along its two principal axes of curvature to remain roughly constant as it flexes. This is in contrast to an elastomeric lens element, which remains flexible along a first axis even when the lens element is curved along a second axis perpendicular to the first axis. The properties of semi-rigid lens elements may allow the semi-rigid lens elements to form a cylindrical lens with tunable lens power and a tunable axis.

Rigid lens elements may be formed from glass, a polymer material such as polycarbonate or acrylic, a crystal such as sapphire, etc. In general, the rigid lens elements may not deform when pressure is applied to the lens elements within the lens module. In other words, the shape and position of the rigid lens elements may be fixed. Each surface of a rigid lens element may be planar, concave (e.g., spherically, aspherically, or cylindrically concave), or convex (e.g., spherically, aspherically, or cylindrically convex). Rigid lens elements may be formed from a material having a Young's modulus that is greater than greater than 25 GPa, greater than 30 GPa, greater than 40 GPa, greater than 50 GPa, etc.

One or more structures such as a lens housing 90 (sometimes referred to as housing 90, lens chassis 90, chassis 90, support structure 90, etc.) may also define the fluid-filled chamber 82 of lens element 72-2.

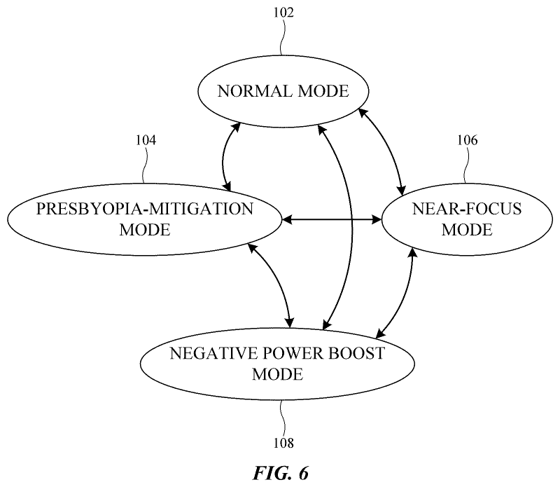

FIG. 5 is a cross-sectional side view of lens element 72-2 showing an illustrative adjustment of the shape of lens element 72-2. As shown, during adjustments of lens element 72-2, lens element 84 may be biased in direction 94 at multiple points along its periphery (e.g., a point force is applied in direction 94 at multiple points). In this way, the curvature of the lens element 84 (and accordingly, the lens power of lens element 72-2) may be adjusted.

There are multiple options for how to manipulate the shape of lens element 84. In one possible arrangement, a plurality of actuators (e.g., linear actuators) may be coupled to the periphery of the lens element. The actuators may be distributed evenly around the periphery of the lens element 84, as one example. Each actuator (e.g., a linear actuator) may be coupled to a respective portion of lens element 84 and may selectively move that respective portion of lens element 84 up and down (e.g., in the Z-direction in FIGS. 4 and 5) to control the position of that respective portion of lens element 84 in the Z-direction. A lens shaping element (e.g., a ring-shaped element) may optionally be coupled to both lens element 84 and the actuators.

The example of tunable lens element 72-2 being a fluid-filled lens element is merely illustrative. In general, tunable lens element 72-2 may be any desired type of tunable lens element with adjustable optical power.

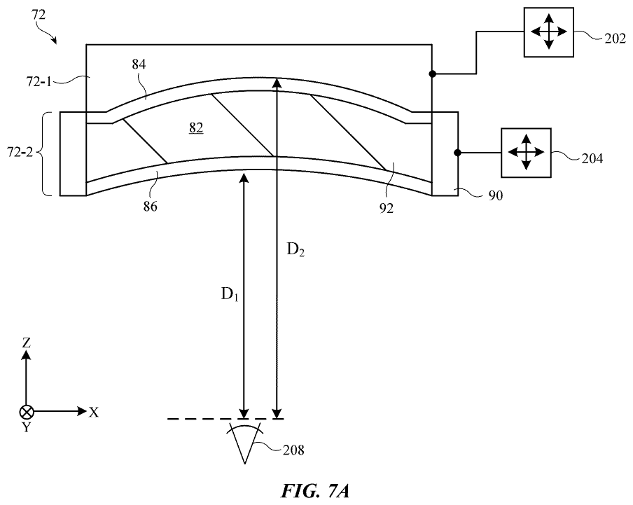

FIG. 6 is a state diagram showing various modes of operation for tunable lens 72-2. Generally, the tunable lens 72-2 may be adjusted to compensate for the user's eyesight. As shown in FIG. 6, the tunable lens is operable in a normal mode 102. In the normal mode, the tunable lens may be set to compensate for a user's eyeglasses prescription. This may be the baseline mode that is used during normal operation of head-mounted device 10. When tunable lens 72-2 is in normal mode 102, the lens module 72 may provide an optical power that matches the user's eyeglasses prescription. If the user does not have an eyeglasses prescription, the optical power of the lens module may be 0 in the normal mode.

Tunable lens 72-2 may also be operable in one or more additional modes. FIG. 6 shows how the tunable lens is operable in a presbyopia-mitigation mode 104, a near-focus mode 106, and a negative power boost mode 108.

The presbyopia-mitigation mode 104 may be used when a user has presbyopia (a refractive error that diminishes the ability of the eye to focus on nearby objects). In the presbyopia-mitigation mode, the tunable lens may be adjusted to have additional positive optical power. For example, in presbyopia-mitigation mode 104 the spherical power of the tunable lens may be increased in a positive magnitude compared to normal mode 102. The magnitude of increase in spherical power of the tunable lens in mode 104 compared to mode 102 may be at least 0.25 diopters, at least 0.5 diopters, at least 1 diopter, at least 1.5 diopters, at least 2 diopters, less than 3 diopters, between 0.5 diopters and 3 diopters, between 1 diopter and 2 diopters, etc. In general, the spherical power may be tuned to any desired dioptric value in presbyopia-mitigation mode 104.

The near-focus mode 106 may be used when users without presbyopia are focusing on nearby objects. When users without presbyopia are focusing on nearby objects, the optical power of the tunable lens may be relaxed (e.g., shifted closer to 0 diopters). For example, a tunable lens with a negative spherical power in normal mode 102 may have its spherical power increased in mode 106 and a tunable lens with a positive spherical power in normal mode 102 may have its spherical power decreased in mode 106. This may be particularly useful for myopic (nearsighted) users. For myopic users, the tunable lens has a negative spherical power in normal mode 102.

The magnitude of change in spherical power of the tunable lens in mode 106 relative to mode 102 may be at least 0.25 diopters, at least 0.5 diopters, at least 1 diopter, at least 1.5 diopters, at least 2 diopters, at least 4 diopters, at least 6 diopters, less than 8 diopters, less than 3 diopters, between 0.5 diopters and 3 diopters, between 1 diopter and 2 diopters, etc. In general, the spherical power may be tuned to any desired dioptric value in near-focus mode 106.

In modes 104 and 106, there may be a threshold distance that defines nearby objects. In other words, objects that are closer to head-mounted device 10 than the threshold distance may be considered nearby objects and objects that are further from head-mounted device 10 than the threshold distance may not be considered nearby objects. Any desired distance may be used for the threshold distance (e.g., one meter, less than one meter, greater than one meter, etc.).

Negative power boost mode 108 may be used for users who may benefit from more negative optical power in low light level conditions and/or when the eye is fatigued (e.g., myopic users). In these conditions, a tunable lens with a negative spherical power in normal mode 102 may have its spherical power decreased in mode 108.

The magnitude of change in spherical power of the tunable lens in mode 108 relative to mode 102 may be at least 0.25 diopters, at least 0.5 diopters, at least 1 diopter, at least 1.5 diopters, at least 2 diopters, at least 4 diopters, at least 6 diopters, less than 8 diopters, less than 3 diopters, between 0.5 diopters and 3 diopters, between 1 diopter and 2 diopters, etc. In general, the spherical power may be tuned to any desired dioptric value in negative power boost mode.

Consider a first user with an eyeglass prescription of −3 diopters for spherical power. In this example, the first user also has presbyopia. In the normal mode 102, tunable lens 72-2 may have a spherical power of −3 diopters. In the presbyopia-mitigation mode 104, tunable lens 72-2 may have a spherical power of −2 diopters. In the negative power boost mode, tunable lens 72-2 may have a spherical power of −4 diopters.

Consider a second user with an eyeglass prescription of −6 diopters for spherical power. In this example, the second user does not have presbyopia. In the normal mode 102, tunable lens 72-2 may have a spherical power of −6 diopters. In the near-focus mode 106, tunable lens 72-2 may have a spherical power of −1 diopters. In the negative power boost mode, tunable lens 72-2 may have a spherical power of −8 diopters.

Consider a third user that does not have an eyeglass prescription but that has presbyopia. In the normal mode 102, tunable lens 72-2 may have a spherical power of 0 diopters. In the presbyopia-mitigation mode 104, tunable lens 72-2 may have a spherical power of +2 diopters.

Tunable lens 72-2 may be adjusted between any of modes 102, 104, 106, and 108 based on a variety of factors. Tunable lens 72-2 may default to normal mode 102. If head-mounted device 10 determines that the user is viewing a nearby object, the tunable lens may be switched to mode 104 (if the user has presbyopia) or mode 106 (if the user does not have presbyopia). If head-mounted device 10 determines that light levels are low, the tunable lens may be switched to mode 108. If head-mounted device 10 determines that the eye fatigue is high, the tunable lens may be switched to mode 108. Data from one or more components in input-output circuitry 16 and/or external equipment 60 may be used to place the tunable lens in an optimal mode.

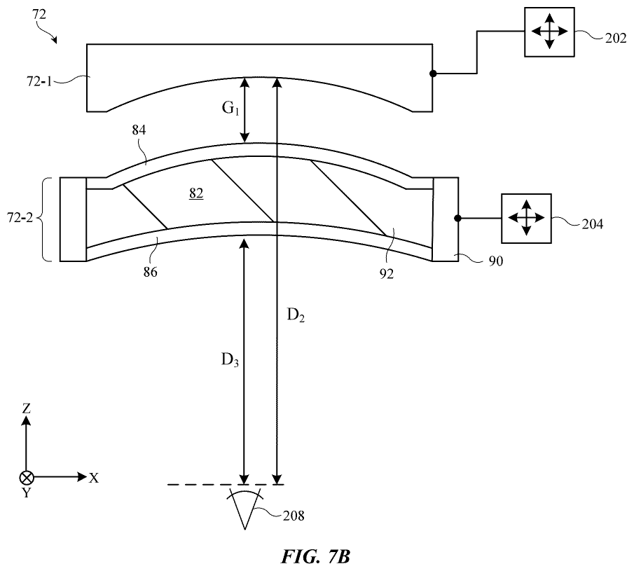

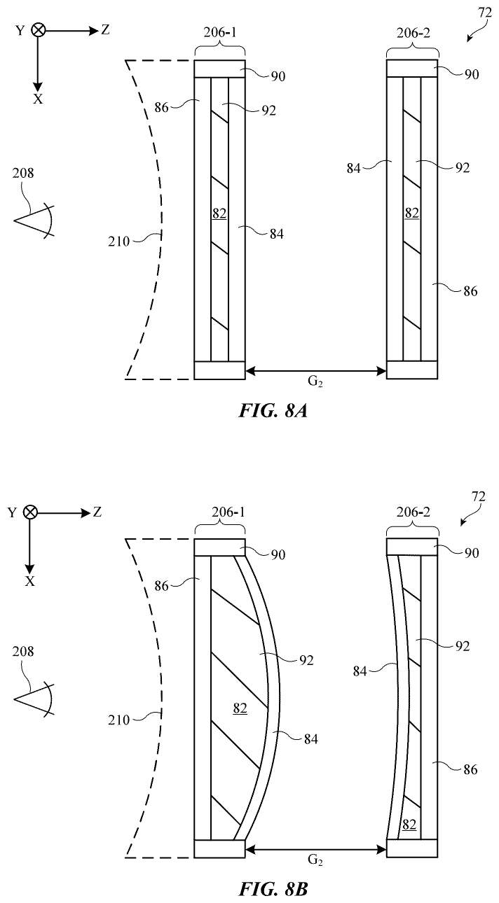

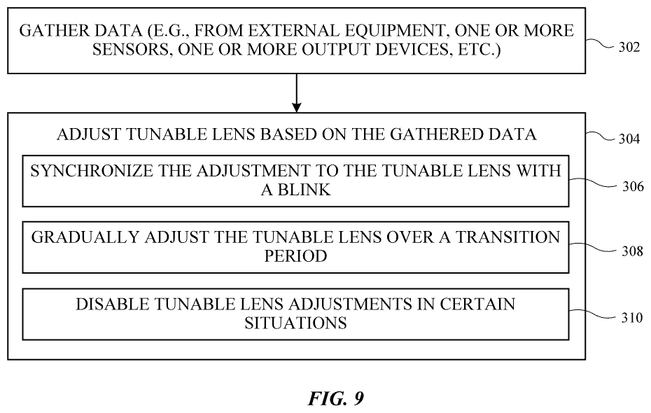

When the optical power associated with a tunable lens in lens module 72 is updated, the perceived magnification associated with the tunable lens may change. If care is not taken, the change in magnification caused changes to the tunable lens may be disorienting or otherwise undesirable for the user of head-mounted device 10. User comfort may therefore be improved by mitigating changes in magnification at different optical powers of lens module 72. One technique (as shown and discussed in connection with FIGS. 7A and 7B) to mitigate changes in magnification at different optical powers is to physically move the tunable lens relative to a non-tunable lens to change a gap between the tunable lens and the non-tunable lens. Another technique (as shown and discussed in connection with FIGS. 8A and 8B) is to include two tunable lenses in the lens module. Instead or in addition, adjustments to a tunable lens in a lens module may be performed during blinks and/or over a transition period (as shown in FIG. 9).

FIGS. 7A and 7B show an illustrative lens module 72 with an adjustable lens 72-2 and a non-adjustable lens 72-1. Non-adjustable lens 72-1 may be a rigid lens element (e.g., formed glass, a polymer material such as polycarbonate or acrylic, a crystal such as sapphire, etc.) as one example. Non-adjustable lens 72-1 provides a fixed optical power within lens module 72 (and is therefore referred to as non-adjustable). The non-adjustable lens 72-1 may, as an example, provide a negative optical power (e.g., less than 0 D, less than −1 D, less than −2 D, etc.). The non-adjustable lens 72-1 may have convex curvature on a first side (e.g., facing away from eye box 208 as in FIG. 7A) and concave curvature on a second, opposing side (e.g., facing towards eye box 208 as in FIG. 7A). Non-adjustable lens 72-1 is arranged along a common optical axis as adjustable lens 72-2. Adjustable lens 72-2 may have the arrangement shown and discussed in connection with FIGS. 4 and 5 or any other desired arrangement.

To mitigate magnification changes caused by changes in the optical power of tunable lens 72-2, one or both of non-adjustable lens 72-1 and adjustable lens 72-2 may be connected to respective positioners (sometimes referred to as computer-controlled positioners). As shown in FIG. 7A, non-adjustable lens 72-1 is connected to a first computer-controlled positioner 202 and adjustable lens 72-2 is connected to a second computer-controlled positioner 204.

Positioner 202 may include stepper motors, piezoelectric actuators, motors, linear electromagnetic actuators, and/or other electronic components for adjusting the position of lens 72-1 within three-dimensional space. For example, positioner 202 may be configured to laterally shift lens 72-1 along the Z-direction (e.g., parallel to the common optical axis of lens module 72). Positioner 202 may be controlled by control circuitry 14 during operation of device 10.

Positioner 204 may include stepper motors, piezoelectric actuators, motors, linear electromagnetic actuators, and/or other electronic components for adjusting the position of lens 72-2 within three-dimensional space. For example, positioner 204 may be configured to laterally shift lens 72-2 along the Z-direction (e.g., parallel to the common optical axis of lens module 72). Positioner 204 may be controlled by control circuitry 14 during operation of device 10.

Positioners 202 and 204 may therefore change the magnitude of a gap between lenses 72-1 and 72-2 and/or the distance between lenses 72-1 and 72-2 and eye box 208. Eye box 208 refers to a volume where the user's eye is expected to be located during normal operation of head-mounted device 10. Changing the magnitude of a gap between lenses 72-1 and 72-2 and/or the distance between lenses 72-1 and 72-2 and eye box 208 in parallel with updates to the optical power provided by adjustable lens 72-2 may mitigate changes in magnification caused by lens module 72.

FIG. 7B shows an example where positioner 204 is used to adjust the position of lens 72-2 relative to lens 72-1. FIG. 7A shows an example where adjustable lens 72-2 is separated from eye box 208 by a first distance D₁ and non-adjustable lens 72-1 is separated from eye box 208 by a second distance D₂. In FIG. 7B, the optical power of adjustable lens 72-2 has been changed (e.g., increased from 0 diopter in FIG. 7A to 3 diopter in FIG. 7B). Also in FIG. 7B, positioner 204 has shifted lens 72-2 in the negative Z-direction towards eye box 208 relative to as in FIG. 7A.

In FIG. 7A, there is little to no gap between lens 72-1 and 72-2 (e.g., the convex surface of lens element 84 in lens 72-2 conforms to the concave surface of lens 72-1). In FIG. 7B, there is a non-zero gap G₁ between lens 72-1 and lens 72-2. Also in FIG. 7B, lens element 84 has more curvature than the concave surface of lens 72-1. The distance D₂ between lens 72-1 and eye box 208 is the same in FIG. 7B as in FIG. 7A. However, the distance D₃ between lens 72-2 and eye box 208 in FIG. 7B is less than the distance D₁ between lens 72-2 and eye box 208 in FIG. 7A.

FIGS. 7A and 7B illustrate how computer-controlled positioners 202 and 204 provide additional degrees of freedom to adjust the gap between lenses 72-1 and 72-2 and/or the distance between lenses 72-1 and 72-2 and the eye box. These additional degrees of freedom may be used to mitigate changes in magnification when the optical power provided by adjustable lens 72-2 is changed.

In one possible arrangement, only one of lenses 72-1 and 72-2 may be configured to shift in the Z-direction. For example, computer-controlled positioner 202 may be omitted from FIGS. 7A and 7B and only lens 72-2 is shifted in the Z-direction. As another example, computer-controlled positioner 204 may be omitted from FIGS. 7A and 7B and only lens 72-1 is shifted in the Z-direction.

In one embodiment, shown in FIG. 7A, lens module 72 may be designed such that there is no gap between lenses 72-1 and 72-2 when the lens module provides no optical power (e.g., 0 diopters). As the optical power of lens 72-2 is increased, the gap between lenses 72-1 and 72-2 is also increased. For example, the gap between lenses 72-1 and 72-2 may have a first magnitude when the optical power of lens 72-2 is a second magnitude, the gap between lenses 72-1 and 72-2 may have a third magnitude that is greater than the first magnitude when the optical power of lens 72-2 is a fourth magnitude that is greater than the second magnitude, the gap between lenses 72-1 and 72-2 may have a fifth magnitude that is greater than the third magnitude when the optical power of lens 72-2 is a sixth magnitude that is greater than the fourth magnitude, etc. In each one of these examples, the magnification associated with lens module 72 may be the same. In other words, controlling the optical power of an adjustable lens synchronously with a gap between the adjustable lens and a non-adjustable lens may enable providing a target optical power with uniform magnification across a range of optical powers.

Said another way, the separation between eye box 208 and lens 72-1 may be fixed (regardless of the optical power of lens 72-2). As the optical power of lens 72-2 is increased, the separation between lens 72-2 and eye box 208 is decreased. For example, the separation between lens 72-2 and eye box 208 may have a first magnitude when the optical power of lens 72-2 is a second magnitude, the separation between lens 72-2 and eye box 208 may have a third magnitude that is less than the first magnitude when the optical power of lens 72-2 is a fourth magnitude that is greater than the second magnitude, the separation between lens 72-2 and eye box 208 may have a fifth magnitude that is less than the third magnitude when the optical power of lens 72-2 is a sixth magnitude that is greater than the fourth magnitude, etc.

In one example, D₁ is equal to 18 millimeters, D₂ is equal to 24 millimeters, G₁ is equal to 7 millimeters, and D₃ is equal to 11 millimeters. These examples are merely illustrative. In general, each one of D₁, D₂, D₃, and G₁ may be greater than 3 millimeters, greater than 5 millimeters, greater than 10 millimeters, greater than 15 millimeters, greater than 20 millimeters, greater than 30 millimeters, greater than 50 millimeters, etc. The range of possible gaps between lens elements 72-1 and 72-2 (as controlled by positioners 202 and/or 204) may extend from 0 to a maximum magnitude of greater than 3 millimeters, greater than 5 millimeters, greater than 10 millimeters, greater than 15 millimeters, greater than 20 millimeters, greater than 30 millimeters, greater than 50 millimeters, etc.

FIGS. 7A and 7B show an example where the gap between an adjustable lens and a non-adjustable lens is adjustable to enable mitigation of magnification changes caused by changes in optical power in the adjustable lens.

FIGS. 8A and 8B show another example where lens module 72 includes two adjustable lenses with a fixed non-zero gap. The optical power of the two adjustable lenses may be updated synchronously to impart a change in the total optical power of lens module 72 without changing magnification.

As shown in FIG. 8A, a first adjustable lens 206-1 and second adjustable lens 206-2 may be included in lens module 72. Each one of adjustable lenses 206-1 and 206-2 may have the arrangement shown for adjustable lens 72-2 in FIGS. 4 and 5 or any other desired adjustable lens arrangement. Adjustable lenses 206-1 and 206-2 may be positioned at respective fixed distances from eye box 208. Accordingly, there is a fixed gap G₂ between adjustable lenses 206-1 and 206-2. The magnitude of G₂ may be greater than 3 millimeters, greater than 5 millimeters, greater than 10 millimeters, greater than 20 millimeters, between 5 millimeters and 15 millimeters, etc.

FIG. 8A shows an example where the optical power of both adjustable lens 206-1 and 206-2 is 0 diopters and the total optical power of the lens module is therefore 0 diopters. FIG. 8B shows an example where adjustable lens 206-1 is adjusted to have a positive optical power and adjustable lens 206-2 is adjusted to have a negative optical power. The total optical power provided by the lens module in FIG. 8B may be positive.

When the total optical power provided by the lens module in FIG. 8B is positive, the absolute value of the positive optical power provided by lens 206-1 may be greater than the absolute value of the negative optical power provided by lens 206-2. In a first arrangement, lens 206-1 has an optical power of 0 D, lens 206-2 has an optical power of 0 D, and lens module 72 has a total optical power of 0 D. In a second arrangement, lens 206-1 has an optical power of +2.7 D, lens 206-2 has an optical power of −1.75 D, and lens module 72 has a total optical power of +1 D. In a third arrangement, lens 206-1 has an optical power of +4.3 D, lens 206-2 has an optical power of −2.7 D, and lens module 72 has a total optical power of +1.5 D. In a fourth arrangement, lens 206-1 has an optical power of +5.4 D, lens 206-2 has an optical power of −3.6 D, and lens module 72 has a total optical power of +2 D. In a fifth arrangement, lens 206-1 has an optical power of +7 D, lens 206-2 has an optical power of −4.7 D, and lens module 72 has a total optical power of +2.5 D.

These examples are merely illustrative. In each one of the first, second, third, fourth, and fifth arrangements listed above, the magnification associated with lens module 72 may be the same. In other words, controlling two adjustable lenses synchronously may enable providing a target optical power with uniform magnification across a range of optical powers.

FIGS. 8A and 8B further show how an optional additional lens element 210 may be formed on lens element 86 of adjustable lens 206-1. As an example, lens element 210 may be three-dimensionally (3D) printed on lens element 86. Lens element 210 may impart an additional prescription on lens module 72.

FIG. 9 is a flowchart of an illustrative method for operating an electronic device with a tunable lens in accordance with some embodiments. During the operations of block 302, the head-mounted device may gather data. The data may be gathered from external equipment 60, from one or more sensors in device 10, from one or more output devices in device 10, etc.

Head-mounted device 10 may wirelessly receive information from external equipment 60 during the operations of block 302. The information received from external equipment may, for example, indicate if the user is actively viewing the external equipment and/or a distance between the external equipment and the head-mounted device. The information received may include raw data (e.g., accelerometer data indicating a raise-to-wake gesture) and/or a notification that the external equipment is being actively viewed (without necessarily including raw data). External equipment 60 may estimate the distance between head-mounted device 10 and the external equipment using ultra-wideband (UWB) communications and/or depth sensing (e.g., using a LIDAR sensor in the external equipment).

Head-mounted device 10 may gather data from one or more sensors during the operations of block 302. The sensors used to gather data during the operations of block 302 may include inward-facing camera 22, outward-facing camera 24, microphone 26, position and motion sensors 28, ambient light sensor 30, magnetometer 32, heart rate monitor 34, depth sensor 36, temperature sensor 38, touch sensor 40, moisture sensor 42, gas sensor 44, barometer 46, gaze-tracking sensor 48, button 50, light-based proximity sensor 52, EOG sensor(s) 53, GPS sensor 54, EMG sensor(s) 55, etc.

As examples, images from outward-facing camera 24 may help identify if the user is actively viewing a nearby object. Position and motion sensors 28 may recognize head gestures associated with the user viewing a nearby object. Ambient light sensor 30 may detect low ambient light levels that trigger the negative power boost mode 108. Depth sensor 36 may help identify if the user is actively viewing a nearby object. Touch sensor 40 and/or button 50 may gather user input that is used to manually adjust a tunable lens. Gaze-tracking sensor 48 may help identify if the user is actively viewing a nearby object and/or may determine pupil size information used to assess light levels and/or eye fatigue. EOG sensor(s) 53 may sense rotation of the user's eye(s) to detect whether the user is focusing on a near object or a distant object. GPS sensor 54 may identify a location of the head-mounted device that influences adjustments of tunable lens 72-2. EMG sensor(s) 55 may sense contraction of a user's trapezius muscle to indicate whether the user is focusing on a near object or a distant object.

In general, data from any one of inward-facing camera 22, outward-facing camera 24, microphone 26, position and motion sensors 28, ambient light sensor 30, magnetometer 32, heart rate monitor 34, depth sensor 36, temperature sensor 38, touch sensor 40, moisture sensor 42, gas sensor 44, barometer 46, gaze-tracking sensor 48, button 50, light-based proximity sensor 52, EOG sensor(s) 53, GPS sensor 54, and EMG sensor(s) 55 may influence adjustments of tunable lens 72-2.

Head-mounted device 10 may gather data associated with one or more output devices during the operations of block 302. The data associated with an output device may include information on whether or not that output device is powered on and/or the type of content being presented if the output device is powered on. For example, the data gathered during the operations of block 302 may include information on whether display 18 in head-mounted device 10 is operating and what type of content is being presented on display 18.

The data gathered during the operations of block 302 may additionally include information on the number and/or type of applications installed on head-mounted device 10, the number and/or type of applications currently running on head-mounted device 10, information from an application running on head-mounted device 10, etc.

The data gathered during the operations of block 302 may include any other desired information (e.g., the time of day, the length of time the head-mounted device 10 has been operated, calendar information for the user of the head-mounted device, etc.).

In general, any of these types of data may influence adjustments of a tunable lens in lens module 72 (e.g., lens 72-2 in FIGS. 7A and 7B or lenses 206-1 and 206-2 in FIGS. 8A and 8B).

Next, during the operations of block 304, head-mounted device 10 may adjust at least one tunable lens in the lens module based on the gathered data from block 302. Adjusting the tunable lens may include adjusting from a normal mode 102 to a presbyopia-mitigation mode 104, adjusting from a normal mode 102 to a near-focus mode 106, adjusting from a normal mode 102 to a negative power boost mode 108, or any other desired adjustments. Adjusting the tunable lens may include adjusting the total optical power provided by the lens module.

Some lens modules may experience a change in magnification when the optical power of a tunable lens in the lens module is updated. Other lens modules may be configured to mitigate changes in magnification when the optical power of a tunable lens in the lens module is updated (e.g., the lens module of FIGS. 7A and 7B or the lens module of FIGS. 8A and 8B). In either scenario, adjustments to the tunable lens may be performed gradually and/or at specific times to improve user comfort while wearing head-mounted device 10.

As shown by the operations of block 306, adjustments to a tunable lens may be synchronized with a detected eye blink from the viewer. In particular, control circuitry 14 may determine during the operations of block 304 (e.g., based on the data from block 302) that an adjustment to the tunable lens is needed. However, after making this determination the control circuitry may hold off on actually making the adjustment to the tunable lens. Subsequently, gaze tracking sensor 48 may detect the start of a user's eye blink. Once the user's eye blink has been detected, the desired adjustment to the tunable lens may be made as quickly as possible. Ideally, the adjustment will have been completed by the time the user's eye blink concludes. If the user's eye blink concludes before the tunable lens adjustment is complete, the adjustment may be completed while the user's eyes are open or may be paused and resumed when the next eye blink is detected by the gaze-tracking sensor. Making adjustments to the tunable lens during one or more blinks may improve user comfort.

As shown by the operations of block 308, adjustments to a tunable lens may be performed gradually over a transition period. Consider an example where the tunable lens changes from 0 D to +2.5 D. If this adjustment is performed as quickly as possible, the adjustment may be performed in less than 200 milliseconds seconds, less than 100 milliseconds, less than 50 milliseconds, etc. To improve user comfort, the adjustment may instead be performed gradually over a transition period. The transition period may be greater than 200 milliseconds, greater than 500 milliseconds, greater than 1 second, greater than 5 seconds, greater than 10 seconds, etc.

Changes to optical power during the transition period may be approximately linear, may follow a step function, and/or may be approximately non-linear. As an example, the optical power may be adjusted from 0 D to +2.5 D over 2.5 seconds, with the optical power following a step function with a +0.1 D increase every 0.1 seconds. This is an example of a step function that approximates a linear change in optical power during the transition period. In general, the optical power may change at any desired rate.

As shown by the operations of block 310, adjustments to the tunable lens may be disabled in certain situations. Adjustments may be disabled when the gathered data from block 302 indicates, as examples, that the user is driving a vehicle, riding a bike, walking on stairs, etc.

The order of blocks 302-310 in FIG. 9 is merely illustrative and in general the operations of each block may be performed in any desired order.

The foregoing is merely illustrative and various modifications can be made to the described embodiments. The foregoing embodiments may be implemented individually or in any combination.

What is claimed is:

1. An electronic device, comprising:
a head-mounted support structure; and
a lens module coupled to the head-mounted support structure, wherein the lens module comprises:
a first lens with a fixed optical power;
a second lens with an adjustable optical power; and
at least one positioner configured to selectively adjust a gap between the first and second lenses.

2. The electronic device defined in claim 1, wherein the at least one positioner is configured to increase a magnitude of the gap between the first and second lenses in response to the adjustable optical power of the second lens being increased.

3. The electronic device defined in claim 1, wherein the at least one positioner is configured to decrease a magnitude of the gap between the first and second lenses in response to the adjustable optical power of the second lens being decreased.

4. The electronic device defined in claim 1, wherein the first lens comprises a material selected from the group consisting of: polymer, glass, and sapphire.

5. The electronic device defined in claim 1, wherein the second lens is a fluid-filled tunable lens with a fluid-filled chamber defined by first and second lens elements.

6. The electronic device defined in claim 5, wherein curvature of the first lens element is changed to adjust the adjustable optical power of the second lens.

7. The electronic device defined in claim 1, further comprising:
control circuitry configured to adjust the adjustable optical power of the second lens.

8. The electronic device defined in claim 7, wherein the control circuitry is configured to adjust the gap between the first and second lenses based on an adjustment to the adjustable optical power of the second lens.

9. The electronic device defined in claim 1, wherein the at least one positioner is configured to change a magnitude of the gap between the first and second lenses in response to the adjustable optical power of the second lens being changed.

10. The electronic device defined in claim 9, wherein changing the magnitude of the gap between the first and second lenses mitigates changes in magnification caused by the change in the adjustable optical power of the second lens.

11. An electronic device, comprising:
a head-mounted support structure;
a lens module coupled to the head-mounted support structure, wherein the lens module is configured to focus light towards an eye box and wherein the lens module comprises a first lens with an adjustable positive optical power and a second lens with an adjustable negative optical power; and
control circuitry configured to change the lens module from a first state with first total optical power to a second state with a second total optical power that is greater than the first total optical power by increasing the adjustable positive optical power of the first lens and decreasing the adjustable negative optical power of the second lens, wherein perceived magnification at the eye box is the same in both the first and second states.

12. The electronic device defined in claim 11, wherein the first lens has an adjustable convex lens element.

13. The electronic device defined in claim 12, wherein the second lens has an adjustable concave lens element.

14. The electronic device defined in claim 13, wherein the first lens is a fluid-filled tunable lens with a fluid-filled chamber defined by first and second lens elements, wherein the first lens element is the adjustable convex lens element, wherein the first lens element is interposed between the second lens element and the second lens, wherein the lens module further comprises an additional lens element, and wherein the second lens element is interposed between the additional lens element and the fluid-filled chamber.

15. The electronic device defined in claim 11, wherein the first and second lenses are separated by a fixed gap.

16. The electronic device defined in claim 15, wherein the fixed gap is greater than 5 millimeters.

17. A method of operating an electronic device with a tunable lens and one or more sensors, comprising:
determining that an optical power adjustment for the tunable lens is needed using data from a first subset of the one or more sensors;
after determining that the optical power adjustment for the tunable lens is needed, detecting an eye blink using a second subset of the one or more sensors; and
after detecting the eye blink using the second subset of the one or more sensors, adjusting an optical power of the tunable lens according to the optical power adjustment.

18. The method defined in claim 17, wherein adjusting the optical power of the tunable lens according to the optical power adjustment comprises adjusting the optical power of the tunable lens during the eye blink.

19. The method defined in claim 17, wherein the second subset of the one or more sensors comprises a gaze-detection sensor.

20. A method of operating an electronic device with a tunable lens and one or more sensors, comprising:
determining that an optical power adjustment for the tunable lens is needed using data from a first subset of the one or more sensors; and
after determining that the optical power adjustment for the tunable lens is needed, adjusting an optical power of the tunable lens over a transition period of at least 200 milliseconds.
